(19) United States
(12) Patent Application Publication
(10) Pub. No.: US 2007/0178939 A1
(43) Pub. Date: Aug. 2, 2007

(54) Method for reducing radio interference between wireless access points

(75) Inventors: Michael Raftelis, San Antonio, TX (US); William Hurst, San Antonio, TX (US); Steven M. Wollmershauser, San Antonio, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/343,497

(22) Filed: Jan. 31, 2006

(51) Int. Cl. H04B 1/00; H04B 1/38

(52) U.S. Cl. 455/560; 455/63.2

(57) ABSTRACT

A system and method are disclosed for reducing radio interference between wireless access points. A system that incorporates teachings of the present disclosure may include, for example, a network management system (NMS) (102) having a controller (103) that manages operations of a plurality of wireless access points (WAPs) (108) by way of a communication system (100) coupled thereto. The plurality of WAPs can conform to one among IEEE's 802.11 a, b, g and n protocols. The controller can be programmed to determine (302) a mode of operations for each of the plurality of WAPs, and selectively reconfigure (308) operations of at least one of the plurality of WAPs to reduce radio interference therebetween. Additional embodiments are disclosed.

### FIELD OF THE DISCLOSURE

The present disclosure relates generally to techniques for reducing radio interference, and more specifically to a method for reducing interference between wireless access points.

### BACKGROUND

Installation of WiFi systems in businesses and residences is growing rapidly. Lack of care during installation of these systems, or uncoordinated modifications or upgrades to WiFi systems can lead to radio interference with other WiFi systems, thereby degrading throughput and range of communications. Accordingly, a need arises for a method to reduce interference between WiFi devices.

### BRIEF DESCRIPTION OF THE DRAWINGS

FIG. 1 is an exemplary block diagram of a communication system operating according to the teachings of the present disclosure;

FIG. 2 is an exemplary block diagram of wireless access points (WAPs) managed by a network management system (NMS) to reduce radio interference between the WAPs operating in a number of dwellings;

FIG. 3 depicts an exemplary flowchart of a method operating in the NMS for reconfiguring a portion of the WAPs of FIG. 2; and

FIG. 4 is a diagrammatic representation of a machine in the form of a computer system within which a set of instructions, when executed, may cause the machine to perform any one or more of the methodologies discussed herein.

### DETAILED DESCRIPTION OF THE DRAWINGS

Embodiments in accordance with the present disclosure provide a method for reducing interference between wireless access points.

In a first embodiment of the present disclosure, a network management system (NMS) has a controller that manages operations of a plurality of wireless access points (WAPs) by way of a communication system coupled thereto, wherein the plurality of WAPs conform to one among IEEE's 802.11a, b, g and n protocols. The controller can be programmed to determine a mode of operations for each of the plurality of WAPs, and selectively reconfigure operations of at least one of the plurality of WAPs to reduce radio interference therebetween.

In a second embodiment of the present disclosure, a computer-readable storage medium operates in a network management system (NMS) having computer instructions for selectively reconfiguring operations of at least one of a plurality of WAPs to reduce radio interference between the plurality of WAPs, wherein the plurality of WAPs conform to one among IEEE's 802.11a, b, g and n protocols.

In a third embodiment of the present disclosure, a wireless access point (WAP) can have a controller that manages operations of a transceiver for communicating with at least one communication device, and a GPS receiver for locating the WAP. The controller can be programmed to transmit to a network management system (NMS) one among a location of the WAP, and a mode of operations for reconfiguring the WAP to reduce radio interference with other WAPs.

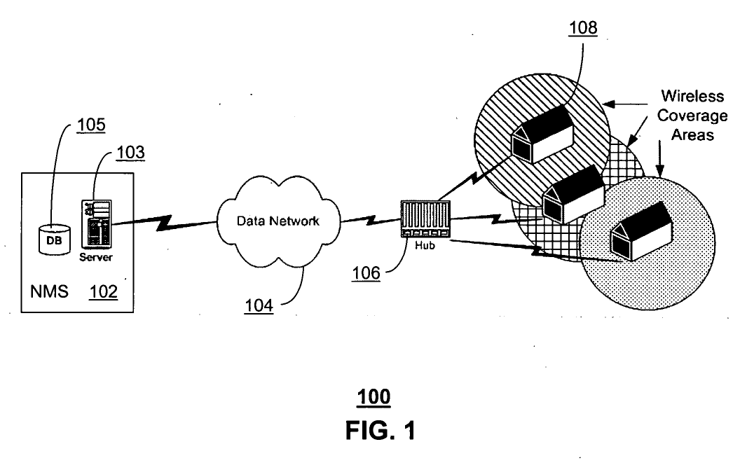

FIG. 1 is an exemplary block diagram of a communication system 100 operating according to the teachings of the present disclosure. The communication system 100 can comprise a plurality of wireless access points (WAPs) 108 each of which operates in dwellings. A hub 106 connects the WAPs 108 in each dwelling to a data network 104 (such as the Internet). The hub 106 can represent network equipment such as fiber, copper or fixed wireless. A network management system (NMS) 102 connects to the WAPs 108 by way of the data network 104 and hub 106. The NMS 102 can include a controller 103 such as a server and integrated or external database 105 for managing operations of the WAPs 108. The NMS 102 can be used for reconfiguring any one of the WAPs 108 to reduce radio interference as will be discussed shortly.

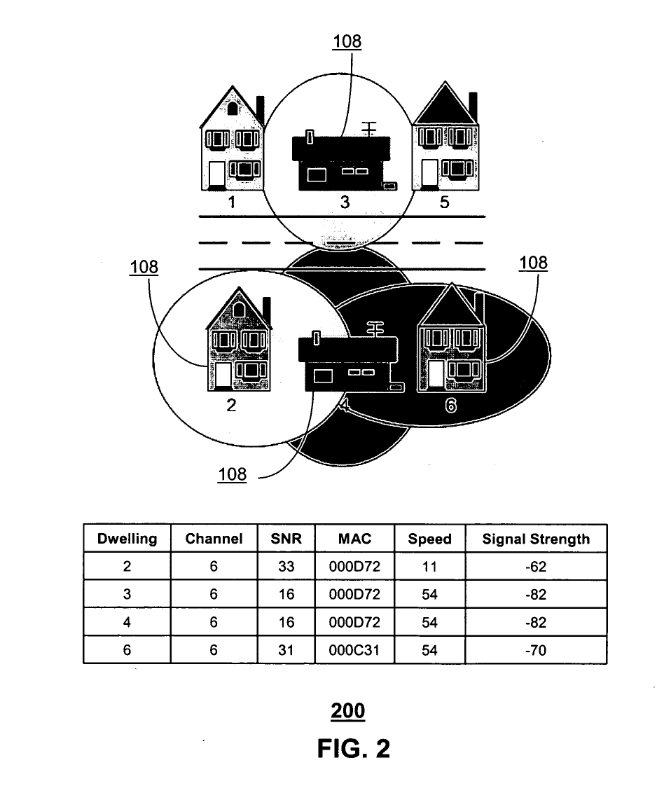

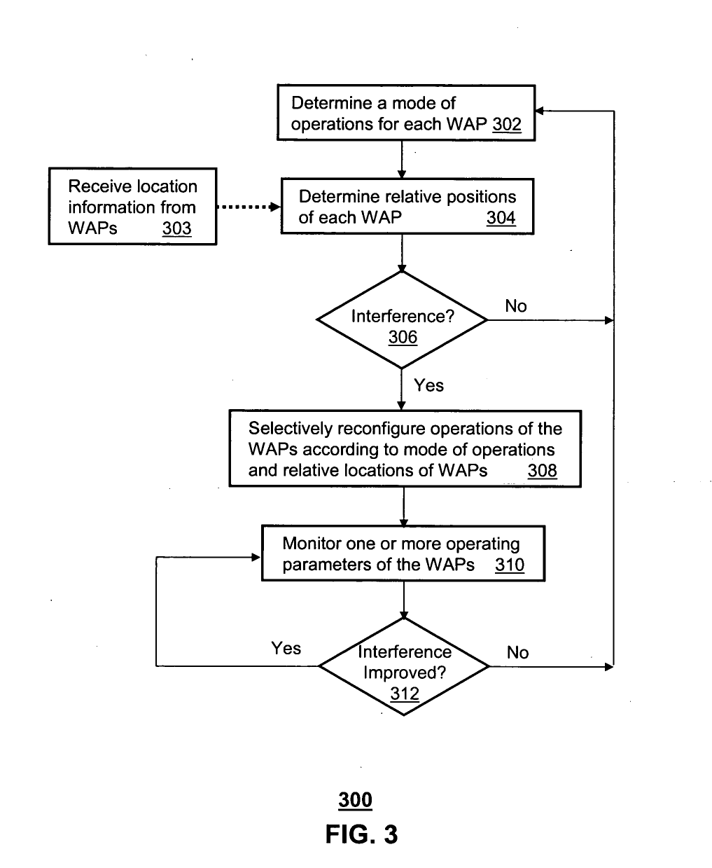

FIG. 2 is an exemplary block diagram of WAPs 108 managed by the NMS 102 to reduce radio interference between the WAPs 108 operating in a number of dwellings. In the present illustration, there are six dwellings shown of which only four utilize WAPs 108 (dwellings 2, 3, 5 and 6). FIG. 3 depicts an exemplary flowchart of a method 300 operating in the NMS 102 for reconfiguring a portion of the WAPs 108 of FIG. 2. Method 300 begins with step 302 where the controller 103 of the NMS 102 can be programmed to determine a mode of operations for each WAP 108. In the present illustration it is assumed that each of the WAPs 108 in dwellings 2, 3, 5 and 6 are accessible and managed by the NMS 102. As will be discussed later, the present disclosure can be applied in cases where one or more of the WAPs 108 may be foreign to the NMS 102, and consequently cannot be managed thereby.

Returning to step 302, the NMS 102 can retrieve operating information from each WAP 108 such as its Service Set Identifier (SSID), and operating parameters including, but not limited to, a frequency channel of operation (e.g., one of channels 1 through 11), the transmission power of said channel, the type of protocol used (IEEE 802.11a, b, g and n), the WAP's MAC address, its maximum and current data rate (e.g., mega bits per second), data error rate (e.g., packet loss rate, bit error rate, etc.), signal to noise ratio, and so on. The SSID and/or MAC (Media Access Control) address can be used in step 304 by the NMS 102 as an index to its database 105 to approximately locate the WAPs 108. Alternatively, a more precise location can be determined from WAPs 108 having an integrated location receiver such as a Global Positioning System (GPS) receiver capable of providing a nearly precise location of the WAP within the dwelling.

From the position and operating parameters of each WAP 108, the controller 103 can be programmed to determine in step 306 which of the WAPs 108 may be experiencing radio interference from overlapping radio coverage areas. In the present illustration, dwellings 2, 3 and 6 overlap with dwelling 4 since each of said dwellings operate on the same frequency channel (i.e., channel 6). To overcome this interference, the controller 103 can be programmed to selectively reconfigure in step 308 a portion of the WAPs 108 to reduce said interference. A possible reconfiguration can accomplish a significant reduction of radio interference by reconfiguring the WAP 108 of dwelling 4 to frequency channel 11. Since channels 11 and 6 do not overlap, the WAPs 108 of dwellings 2, 3 and 6 would not interfere with the WAP 108 of dwelling 4. To reduce potential interference between dwellings 2, 3 and 6, the controller 103 can be further programmed in step 308 to reduce the transmission power of the WAPs 108 in said dwellings to reduce a potential overlap therebetween.

In step 310, the controller 103 can be programmed to monitor one or more operating parameters of the WAPs 108 to determine if the reconfiguration step 308 was effective in reducing or eliminating radio interference between the WAPs 108 of said dwellings. The controller 103 can, for example, compare the previous bit error rate (BER) or packet loss rate to the BER and/or packet loss rate after reconfiguration. Using common mitigation techniques for reducing co-channel interference, the controller 103 can be programmed to determine in step 312 if interference can be improved with an alternativere configuration. If an improvement can be made, and said improvement is more than nominal, the controller 103 can proceed to step 308 to reconfigure one or more WAPs 108. Otherwise, the controller 108 can proceed to step 302 where it repeats the foregoing procedure for new and/or existing WAPs 108.

It will be appreciated by one of ordinary skill in the art that method 300 can be altered without departing from the scope of the claims described below. For instance, a step can be added to method 300 in which a field technician can be deployed to an area within the vicinity of the dwellings of FIG. 2 to conduct a survey with radio measurement equipment to determine which dwellings may be interfering with each other. This step can be especially useful in cases where one or more WAPs 108 of one of said dwellings may be managed by a service operator other than the service operator of the NMS 102. In such instances, the NMS 102 reconfigures WAPs 108 it has access to around the fixed setting of foreign WAPs 108.

It would also be appreciated by an artisan with skill in the art, that method 300 can be applied to dwellings having more than one WAP used in a commercial or residential setting. Moreover, the NMS 102 can be programmed with conventional three-dimensional radio simulation technology so as to determine an interference model in 3-D, from which it can thereby extract a reconfiguration model to reduce radio interference between WAPs operating on the same or different floors of a building. Additionally, method 300 can also be modified so as to reduce interference between WAPs operating in open spaces such as parks or other private or public open areas.

The innumerable embodiments of the present disclosure can best be described by the claims described below.

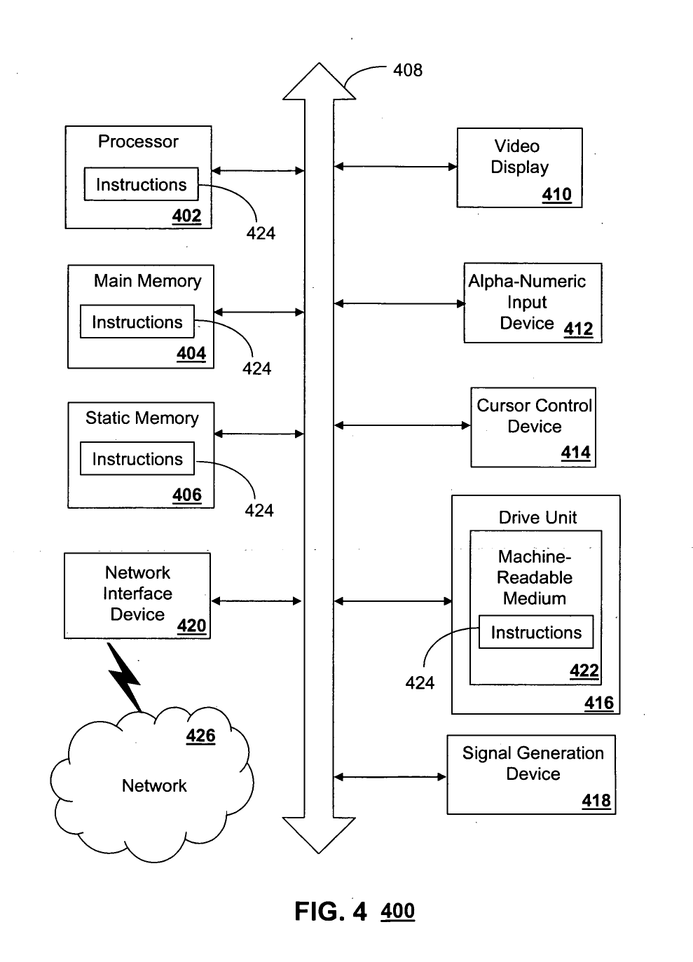

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be reduced. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A network management system (NMS), comprising:
a controller that manages operations of a plurality of wireless access points (WAPs) by way of a communication system coupled thereto, wherein the plurality of WAPs conform to one among EEEE's 802.11 protocols, and wherein the controller is programmed to:
determine a mode of operations for each of the plurality of WAPs; and
selectively reconfigure operations of at least one of the plurality of WAPs to reduce radio interference therebetween.

2. The NMS of claim 1, wherein the controller is programmed to select one among channels 1, 6 and 11 to reduce radio interference of the at least one of the plurality of WAPs.

3. The NMS of claim 1, wherein the controller is programmed to selectively reconfigure operations of the at least one of the plurality of WAPs according to at least one among a physical location of each of the plurality of WAPs, relative positions of the plurality of the WAPs, and operating parameters of the plurality of WAPS.

4. The NMS of claim 3, wherein the operating parameters comprise at least one among a transmission power level and a channel of operation for each of the WAPs.

5. The NMS of claim 1, wherein the NMS is remotely located from the plurality of WAPs.

6. The NMS of claim 1, wherein portions of the plurality of WAPs are located within one among a residence, and a commercial building.

7. The NMS of claim 1, wherein the controller is programmed to:
receive location readings from a portion of the plurality of WAPs; and
reconfigure the at least one of the plurality of WAPs according to the location readings.

8. The NMS of claim 1, wherein the controller is programmed to:
determine a location for each of the plurality of WAPs according to a Service Set Identifier (SSID) of each of the WAPs; and
reconfigure the at least one of the plurality of WAPs according to its location.

9. The NMS of claim 1, wherein the controller is programmed to:
monitor at least one operating parameter of a portion of the plurality of WAPs; and
if radio interference between the WAPs can be improved, reconfigure operations of a portion of the plurality of WAPs while monitoring for an improvement in the at least one operating parameter of the portion of the plurality of WAPs.

10. The NMS of claim 9, wherein the at least one operating parameter comprises at least one among a data error rate, a signal to noise ratio, and a maximum data rate of a select WAP.

11. A computer-readable storage medium in a network management system (NMS), comprising computer instructions for selectively reconfiguring operations of at least one of a plurality of WAPs to reduce radio interference between the plurality of WAPs.

12. The storage medium of claim 11, comprising computer instructions for selecting one among channels 1, 6 and 11 to reduce radio interference of the at least one of the plurality of WAPs.

13. The storage medium of claim 11, comprising computer instructions for selectively reconfiguring operations of the at least one of the plurality of WAPs according to at least one among a physical location of each of the plurality of WAPs, relative positions of the plurality of the WAPs, and operating parameters of the plurality of WAPS.

14. The storage medium of claim 13, wherein the operating parameters comprise at least one among a transmission power level and a channel of operation for each of the WAPs.

15. The storage medium of claim 11, wherein the NMS is remotely located from the plurality of WAPs, and wherein the plurality of WAPs are located within one among a residence, and a commercial building.

16. The storage medium of claim 11, comprising computer instructions for reconfiguring the at least one of the plurality of WAPs according to location readings received from a portion of the plurality of WAPs.

17. The storage medium of claim 11, comprising computer instructions for reconfiguring the at least one of the plurality of WAPs according to its location relative to the other WAPs.

18. The storage medium of claim 11, comprising computer instructions for
monitoring at least one operating parameter of a portion of the plurality of WAPs, wherein the at least one operating parameter comprises at least one among a data error rate, a signal to noise ratio, and a maximum data rate of a select WAP; and
if radio interference between the WAPs can be improved, reconfiguring operations of a portion of the plurality of WAPs according to the at least one operating parameter monitored.

19. A wireless access point (WAP), comprising a controller that manages operations of a transceiver for communicating with at least one communication device, and a GPS receiver for locating the WAP, wherein the controller is programmed to transmit to a network management system (NMS) one among a location of the WAP, and a mode of operations for reconfiguring the WAP to reduce radio interference with other WAPs.

20. The WAP of claim 19, wherein the controller is programmed to receive reconfiguration information from the NMS for reducing radio interference with other WAPs.

21. A method for configuring a plurality of wireless access points (WAPs), comprising:
surveying operations of the plurality of WAPs; and
reconfiguring a portion of the plurality of WAPs to reduce radio interference therebetween.
